(19) United States
(12) Patent Application Publication
(10) Pub. No.: US 2016/0234774 A1
(43) Pub. Date: Aug. 11, 2016

(54) USER EQUIPMENT ACCESS-BASED MACHINE TO MACHINE COMMUNICATION MECHANISM

(71) Applicant: NOKIA SOLUTIONS AND NETWORKS OY, Espoo (FI)

(72) Inventors: Benny VEJLGAARD, Gistrup (DK); Rapeepat RATASUK, Hoffman Estates, IL (US); Lei DU, Beijing (CN); Amitabha GHOSH, Buffalo Grove, IL (US)

(21) Appl. No.: 15/022,294

(22) PCT Filed: Apr. 16, 2014
(86) PCT No.: PCT/EP2014/057783

§ 371 Date: Mar. 16, 2016

Related U.S. Application Data
(60) Provisional application No. 61/878,381, filed on Sep. 16, 2013.

(51) Int. Cl. H04W 52/02; H04W 4/00; H04W 64/00; H04W 52/28; H04W 76/04; H04J 11/00; H04W 72/04

(52) U.S. Cl. CPC H04W 52/0209; H04J 11/00; H04W 4/005; H04W 72/0413; H04W 72/042; H04W 52/28; H04W 76/046; H04W 64/003; H04W 88/06

(57) ABSTRACT

Various communication systems may benefit from mechanisms for access-based communications. For example, machine-type communication in long term evolution (LTE) communication systems may benefit from a mechanism for user equipment access-based machine-to-machine communication. A method can include a user equipment entering a transaction state. The method can also include suspending reception of paging messages during an idle period of the transaction state.

### CROSS-REFERENCE TO RELATED APPLICATION

This application claims the benefit and priority of U.S. Provisional Patent Application No. 61/878,381 filed Sep. 16, 2013, which is hereby incorporated herein by reference in its entirety.

### BACKGROUND

1. Field

Various communication systems may benefit from mechanisms for access-based communications. For example, machine-type communication in long term evolution (LTE) communication systems may benefit from a mechanism for user equipment access-based machine-to-machine communication.

2. Description of the Related Art

Machine to Machine (M2M) or Machine Type Communication (MTC) is a form of data communication that involves one or more entities that do not necessarily need human interaction. Machine-type communication is described in third generation partnership project (3GPP) technical specification (TS) 22.368 v11.4.0, “Service requirements for Machine-Type Communications,” which is hereby incorporated herein by reference in its entity. As specified, M2M communication can be characterized by various MTC features such as, for example, a large number of devices, small data transmission, low mobility and the like.

Long term evolution (LTE) user equipment (UE) devices are required to continuously listen to paging from the network. The paging distance in LTE conventionally is broadcasted such that the UE know when to wake up to listen for a paging message. The maximum paging distance in LTE (Rel. 8-11) is 2.56 s, which means that the UE has to wake up every 2.56 s to listen for paging message. This consumes current, despite the infrequent data transmission of, for example, vending machines. Moreover, this current consumption can limit the standby time of a UE. In LTE Rel. 12 the maximum paging distance may be extended to enhance UE standby time.

3GPP technical report (TR) 23.887 describes a Power Saving State for Devices. This state is defined as follows: “UE can be configured so that the UE is reachable for downlink data only during the time that the UE is in RRC/S1 connected state plus an active time period that follows the connected state during which the UE is reachable for paging.”

These methods can extend the battery life by extending the sleep time while still allowing paging to the UE despite the relatively long DL delay. This active time associated with every connection cycle may still require significant current consumption, particularly in view of network communication having an hourly or daily frequency, which may still be much more frequent than the device's need.

### SUMMARY

According to a first embodiment, a method can include a user equipment entering a transaction state. The method can also include suspending reception of paging messages during an idle period of the transaction state.

The suspending reception of paging messages can include paging not being supported by the user equipment during the idle period or paging being supported but suspended by the network during the idle period.

The method can further include reconnecting to a radio access network when the idle period ends or when the user equipment has data to send on uplink.

The reconnecting comprises sending a tracking area update message or a radio resource control message.

The method can additionally include receiving downlink data during an active period after reconnection to the radio access network.

The method can also include re-entering the idle period after receiving the downlink data or a message, such as a radio resource control message.

The method can further include negotiating or re-negotiating a periodicity of the transaction state.

The transaction state can be for mobile-originated traffic.

According to a second embodiment, a method can include a network element, such as a mobility management entity, determining that a user equipment is in an idle period of a transaction state. The method can also include receiving downlink data for the user equipment while the user equipment is in an idle period. The method can further including holding the downlink data as pending until the user equipment connects to a radio access network.

The method can also include negotiating or renegotiating a periodicity of the transaction state.

The method can further include notifying at least one other network element that the user equipment is in an idle period in response to receiving an indication that data is to be sent to the user equipment.

The method can additionally include configuring the user equipment to go into the transaction state.

According to third and fourth embodiments, respectively, an apparatus can include means for performing the method of the first or second embodiment.

According to fifth and sixth embodiments, respectively, an apparatus can include at least one processor and at least one memory including computer program code. The at least one memory and the computer program code can be configured to, with the at least one processor, cause the apparatus at least to perform the method according to the first or the second embodiment.

According to seventh and eighth embodiments, respectively, a non-transitory computer-readable medium can be encoded with instructions that, when executed in hardware, perform a process. The process can be the method according to the first or the second embodiment.

According to ninth and tenth embodiments, respectively, a computer program product can be encoded with instructions to perform a process. The process can be the method according to the first or the second embodiment.

According to eleventh and twelfth embodiments, respectively, a system can include the apparatus according to the third and fourth embodiments or the fifth and sixth embodiments.

### BRIEF DESCRIPTION OF THE DRAWINGS

For proper understanding of the invention, reference should be made to the accompanying drawings, wherein:

FIG. 1 illustrates a state diagram of M2M UE power-up and configuration of a periodic transaction cycle, according to certain embodiments.

FIG. 2 illustrates M2M UE device states with UE initiated access only and configuration of the periodic transaction cycle, according to certain embodiments.

FIG. 3 illustrates periodic transaction cycle communication between the UE and the network, according to certain embodiments.

FIG. 4 illustrates a signaling procedure for how the UE initiated access can be used to trigger downlink (DL) data transmission, according to certain embodiments.

FIG. 5 illustrates a method according to certain embodiments.

FIG. 6 illustrates a system according to certain embodiments.

### DETAILED DESCRIPTION

Certain embodiments may be applicable to machine-type communication (MTC) systems having enhanced coverage for machine-to-machine communication (M2M), such as meter reading devices. Moreover, certain embodiments may be applicable to low cost devices, having a relatively low level of complexity. Furthermore, certain embodiments may be applicable to user equipment (UE) devices having a UE current consumption that can permit a battery lifetime up to 20 years based on 2 AA batteries.

A M2M UE device's typical use case is to be on standby and transmit or receive low amount of data on regular basis. Such a use case could be in a vending machine to send a message that the vending machine is low on certain merchandise. Another such use case would be for a water meter to send a meter reading. For these use cases, the devices are mostly transmitting status up to the network. They do not require frequent updates from the network but rather daily, monthly, or, for some applications, yearly updates. Furthermore, network access to these devices (i.e. network initiated access) may be predetermined to occur only at a specific time period. For such applications, the standby time of the UE can help to permit recharging or exchanging of batteries to be infrequent. Certain embodiments, therefore, can significantly extend the battery lifetime of a M2M device.

For example, certain embodiments provide a communication method in which the UE communicates with the network on predetermined time intervals and can be accessed during those intervals only, to preserve as much energy as possible to provide a long battery life.

Certain embodiments provide that M2M UE devices that only require UE initiated access or periodic access do not require listening to paging. Furthermore, a periodic communication between the UE and the network can be performed to ensure the network has information that the M2M device is alive. The frequency of UE and network communication can be established during the power-up of the UE device and can be changed during the next communication session between the UE and the network.

The network can fully determine the periodic cycles of the M2M device communication, to ensure that the network can control minimum assess and keep alive knowledge of the UE. In other words, the network can maintain status information regarding whether the UE is alive and performing normally.

The UE can be pre-programmed with a minimum transaction cycle, which can be changed during the first power-up event of the UE. From the UE side, the UE can be pre-configured with the MTC feature mobile-originated—“MO-originated.” With this pre-configuration, the UE can know that the UE is MO-originated and can then inform the network accordingly. The “MO-originated” can be one of the MTC features in 3GPP. From the network side, the network can get this information by downloading the UE context from a home subscriber server (HSS) and/or MTC server. The HSS can store UE related features. The MTC server can know about the application. When the UE accesses to the network, the network can configure this “MO-originating” feature to the UE. The network can also configure related parameters at the same time. For example, in certain embodiments a network can configure an idle period length using, for example, a timer.

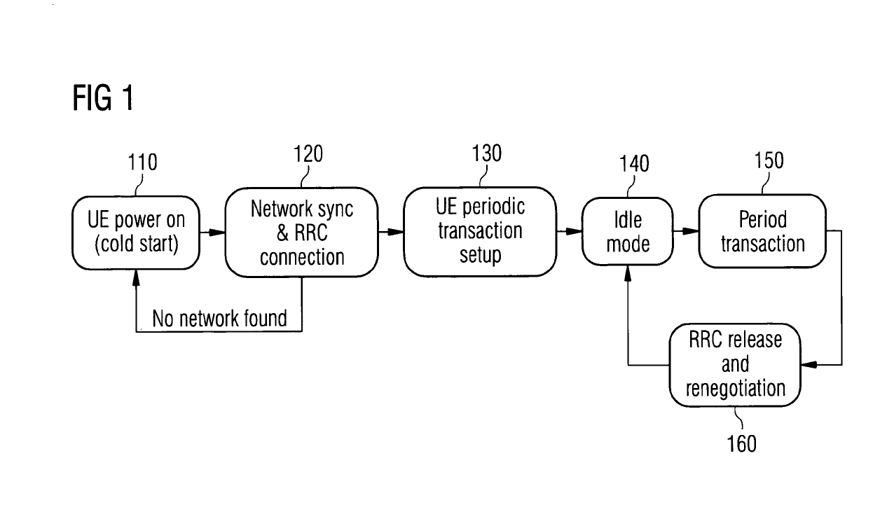

FIG. 1 illustrates a state diagram of M2M UE power-up and configuration of a periodic transaction cycle, according to certain embodiments. Thus, FIG. 1 provides a UE state diagram of the communication flow for a M2M device without paging.

As shown in FIG. 1, at 110, the UE can power on, for example from a cold start. Then, at 120, the UE can sync and a RRC connection can be formed. If no network is found or an RRC connection cannot be set up, the device can try again from a cold start at a later time. Subsequently, at 130, the UE periodic transaction setup can occur. Next, at 140, the UE can enter an idle mode. A periodic transaction can occur at 150, followed by RRC release and renegotiation, at 160.

As shown in FIG. 1, the exchange of information from the network to the UE and vice-versa for the periodic communication cycle (from the network), battery level, location information, or the like (from the UE to the network) can be accomplished via a new RRC release or establishment message or a point-to-point data exchange between the M2M device and the network.

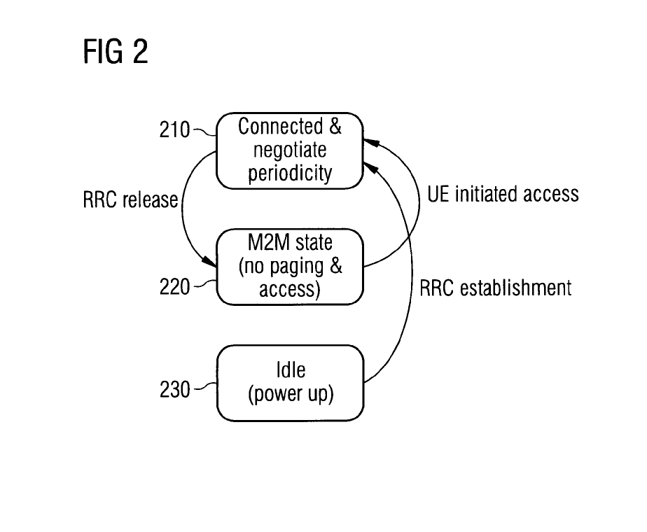

FIG. 2 illustrates M2M UE device states with UE initiated access only and configuration of the periodic transaction cycle, according to certain embodiments.

As shown in FIG. 2, at 210, the UE device can be in a state in which it is connected and can negotiate periodicity. After an RRC release, at 220 the UE can be in a M2M state without paging or access. Then, upon UE initiated access, the UE can return to a connected state. Additionally, the UE can got from an idle period, at 230, to the connected state at RRC establishment.

If the UE fails to communicate with the network on the agreed transaction cycles, the network can assume that the UE is out of service for at least one of various reasons, for example low battery, fault in the UE, change of location, out of coverage, or the like. The network can notify the MTC server or serving gateway (SGW)/packet data network (PDN) gateway (PGW) to suspend the downlink data, for example until the UE wakes up in the next cycle. The period of the UE transaction can include timing inaccuracy in the UE timing reference, which can vary for low power real-time clocks.

The UE timing can be done with a low power real-time clock which has a fairly large inaccuracy. A typical inaccuracy of a low power real-time clock may be about +/−20 ppm and therefore, a window of −20ppm can be accepted by the network before it determines that the UE has lost communication to the network. An example of such window size for weekly updates with 20 ppm can be about 12 seconds.

As a further option, the UE initiated access can be used to trigger DL data transmission, if there has been data arrival at the network. To achieve this, the network can remember whether there is a mobile-terminating access request while the UE is in M2M state and can then dispatch the information to the UE when the UE initiates the access according to the periodic transaction cycle.

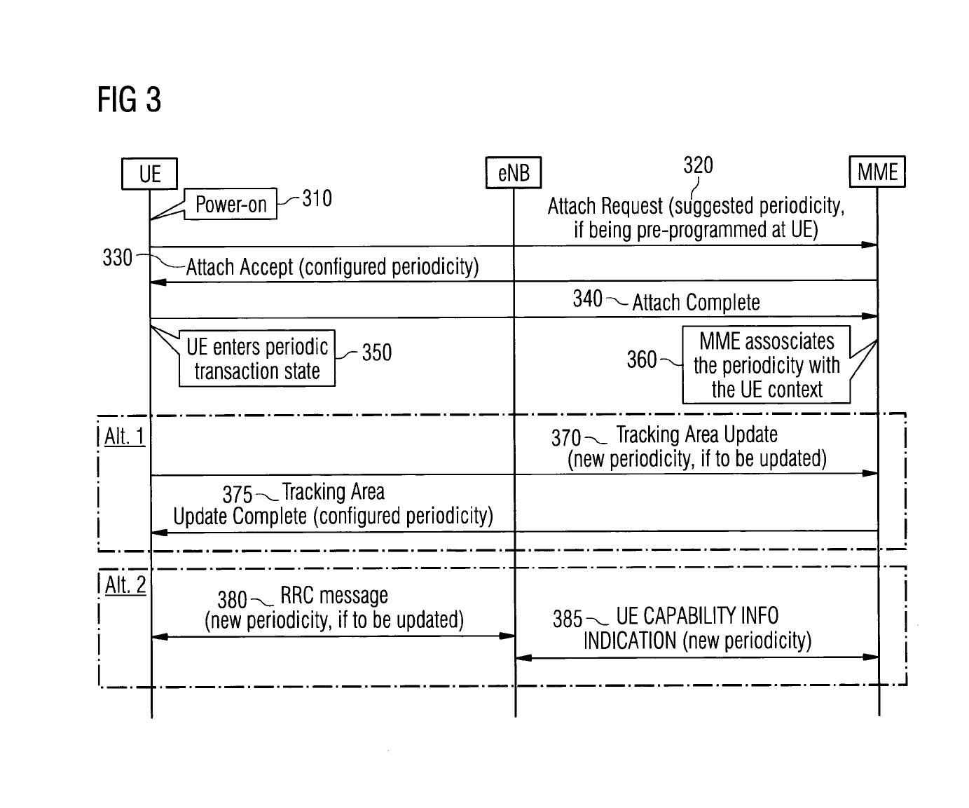

FIG. 3 illustrates periodic transaction cycle communication between the UE and the network, according to certain embodiments. Thus, FIG. 3 provides signaling procedures for how the periodic transaction state can be communicated/updated.

As shown in FIG. 3, at 310 the UE can power on. Then, at 320, the UE can send an attach request to the MME. The attach request can include a suggested periodicity, if the UE is pre-configured to suggest a periodicity. At 330, the MME can provide an attach accept. The accept message can indicate the configured periodicity. The UE can then, at 340, respond with an attach complete message. After attach, the UE can enter a periodic transaction state at 350. Meanwhile, at 360, the MME can associate the configured periodicity with the UE context.

In other words, when the UE is powered on, the UE can negotiate a proper periodic transaction cycle with the network and then the UE can go to idle mode without monitoring paging. If there is no data activity for the length of periodic transaction cycle, the UE can initiate access to trigger downlink data, if available from the network. Note that the cycle may apply only to triggering downlink data. The UE can wake up any time that there is mobile-originating access, for example due to traffic arrival. The periodicity can be initiated from either UE or the network, and the network can determine whether the UE or the network initiates periodicity.

The periodicity in the first message of FIG. 3, for example the attach message, may be optional. If such an indication of periodicity is absent, then the periodicity can become a network initiated process.

If the periodic transaction cycle is to be changed, the new periodicity can be exchanged between the UE and the network in at least two alternatives. The change in periodic transaction cycle may be, for example, because of the change of application or decision of network.

As shown in FIG. 3, according to a first alternative, a new periodic transaction cycle can be exchanged using a non-access stratum (NAS) message directly between UE and the network. For example, this exchange can be performed using a tracking area update (TAU) procedure or UE context modification procedure. Thus, as shown in FIG. 3, at 370 the UE can send a TAU to the MME. The TAU can include a new periodicity, if the periodicity is to be updated. Then, at 375, the MME can respond with a TAU complete message, which can include an indication of the configured periodicity.

As shown in FIG. 3, according to a second alternative, the new periodic transaction cycle can be sent to an evolved Node B (eNB) while the UE is in connected mode using some radio resource control (RRC) message at 380. The message can include a new periodicity, if the periodicity is to be updated. The connection can initially be set up to deliver the mobile-originated (MO-originated) data. After the RRC message, the eNB can, at 385, deliver the value to MME via an S1/Iu interface. As an example, the RRC message may be a UE assistance information message, a UE capability transfer message, or an RRC connection reconfiguration message. The S1/Iu message may indicate UE capability.

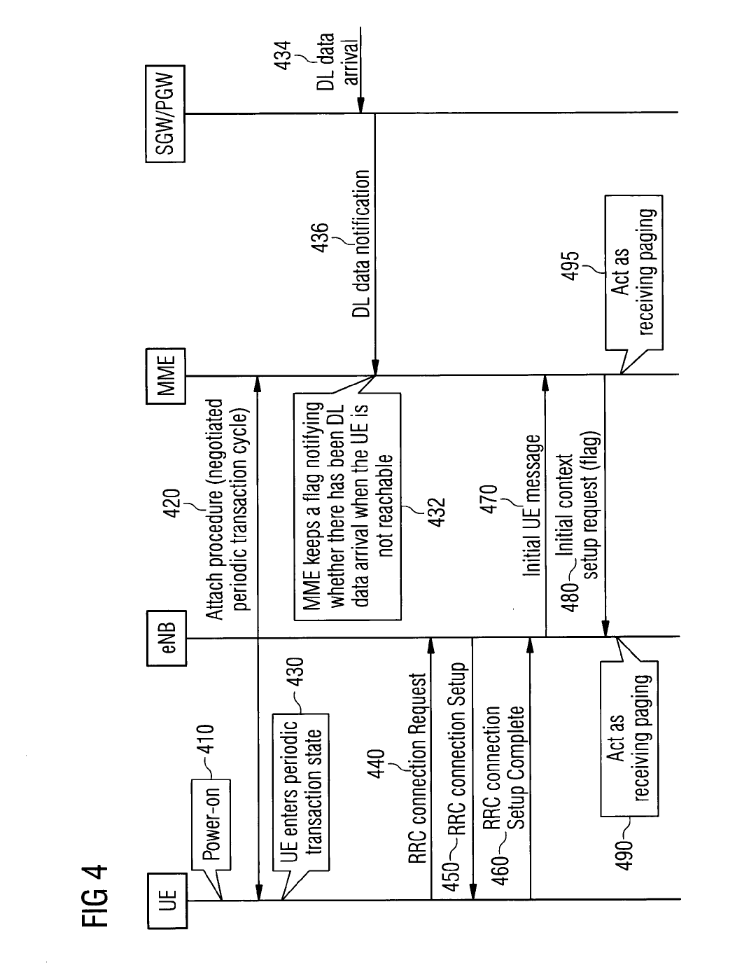

FIG. 4 illustrates a signaling procedure for how the UE initiated access can be used to trigger downlink (DL) data transmission, according to certain embodiments.

As shown in FIG. 4, at 420 a UE can negotiate a timer with the MME when the UE powers-on at 410. The UE can, at 430, enter a periodic transaction state. Meanwhile, at 432 the MME can keep a flag notifying whether there has been DL data arrival when the UE is not reachable. Thus, when DL data arrives at an SGW/PGW, the SGW/PGW can send a DL data notification to the MME at 436.

When there is paging destined to some UE, the MME can check whether the UE is mobile-originated only and marks “yes” which means there has been mobile terminating data before the UE sends data next time.

The UE can wake up and can send reports to the eNB according to the timer. For example, at 440 the UE can send an RRC connection request, and can receive an RRC connection setup message from the eNB at 450. The UE can then send an RRC connection setup complete message at 460.

When the eNB sets up S1 with the MME at 470 with an initial UE message, the

MME can know whether the mark is “yes” or “no” and can then continue requesting downlink packets, if still in the PGW, as expected after sending the paging message. The MME can respond to the eNB at 480 with an initial context setup request, including a flag. Then, the eNB can act as receiving paging at 490, while the MME can act as receiving paging at 495.

Various embodiments may have certain advantages or benefits. For example, certain embodiments may be able to flexibly meet an extreme battery lifetime of M2M devices of 10-20 years.

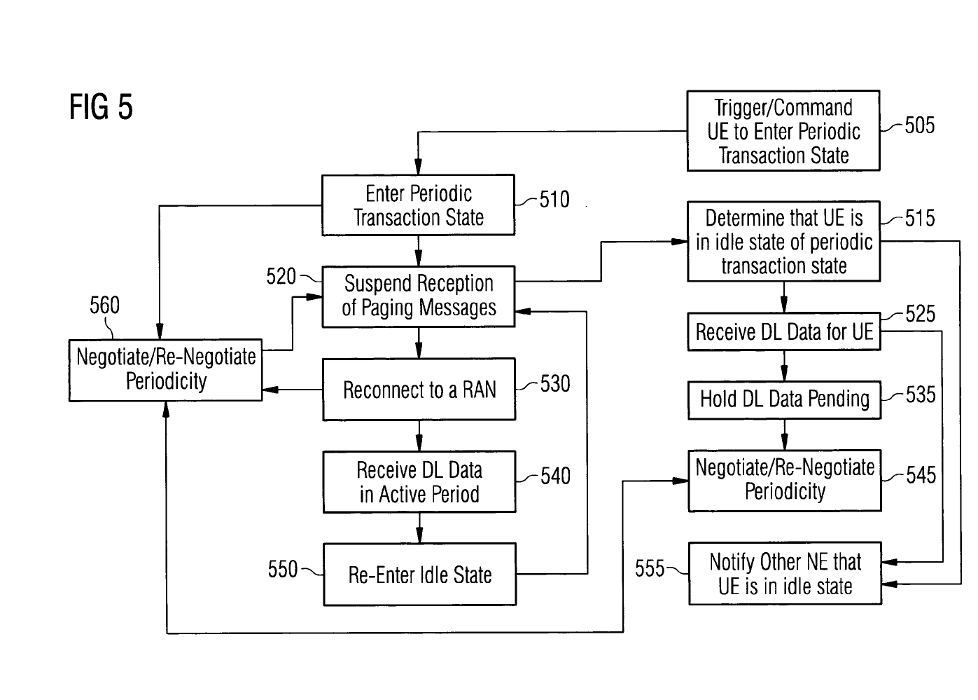

FIG. 5 illustrates a method according to certain embodiments. As shown in FIG. 5, a method can include, at 510, a user equipment entering a periodic transaction state. The periodic transaction state can, for example, be for mobile-originated traffic. Thus, for example, the UE can be pre-configured with the MTC feature mobile-originated—“MO-originated,” as mentioned above.

The method can also include, at 520, suspending reception of paging messages during an idle period of the periodic transaction state. In other words, the user equipment may go into a suspended mode in which the user equipment does not listen for paging messages. Thus, even if paging messages are incident on an antenna of the user equipment, the user equipment may not detect such messages.

The suspending reception of paging messages can include at least two cases. In a first case, paging may simply be unsupported during the idle period. Alternatively, paging may be supported but suspended by the network during the idle period. Thus, it still may be possible to having paging if the network wants to configure it, in this second case.

The method can further include, at 530, reconnecting to a radio access network when the idle period ends or when the user equipment has data to send on uplink. The reconnecting comprises sending a tracking area update message or a radio resource control message, as shown in alternatives 1 and 2 in FIG. 3.

As shown in FIG. 5, the method can additionally include, at 540, receiving downlink data during an active period after reconnection to the radio access network at 530. The method can also include, at 550, re-entering the idle period after receiving the downlink data or a message such a radio resource control message, for example radio resource control connection release.

The method can further include, at 560, negotiating or re-negotiating a periodicity of the periodic transaction state.

The method can also include a network element, such as a mobility management entity, determining, at 515, that a user equipment is in an idle period of a periodic transaction state. In other words, the determination can be that the user equipment will experience extended periods where the user equipment is not available for paging. The method can also include, at 525, receiving downlink data for the user equipment while the user equipment is in an idle period. The method can further including, at 535, holding the downlink data as pending until the user equipment connects to a radio access network. Holding the data as pending may include storing the data locally or in a server that is configured to store data for the user equipment. Alternatively, the holding the data can include requesting the sending device to store the data or resend the data at a later time.

The method can additionally include, at 545, negotiating or renegotiating a periodicity of the periodic transaction state.

The method can further include, at 555, notifying at least one other network element that the user equipment is in an idle period in response to receiving an indication that data is to be sent to the user equipment.

The method can additionally include, at 505, configuring the user equipment to go into the periodic transaction state. Alternatively, the user equipment can be preconfigured to be in a periodic transaction state. For example, the provider of a smart meter may pre-configure the device to always be in a periodic transaction state, or to go into a periodic transaction state based on some trigger, such as a command from the network or a period of time elapsing without activity.

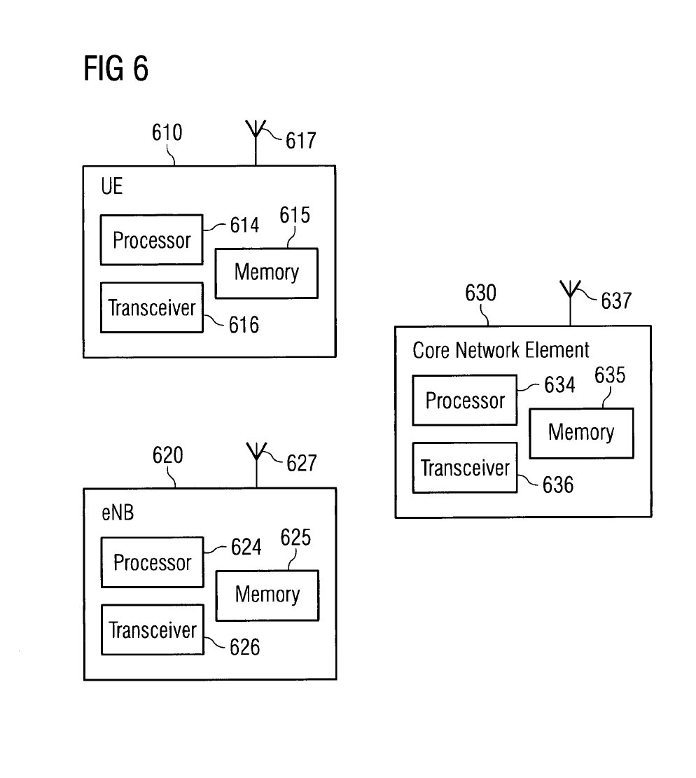

FIG. 6 illustrates a system according to certain embodiments of the invention. In one embodiment, a system may include multiple devices, such as, for example, at least one UE 610, at least one eNB 620 or other base station or access point, and at least one core network element 630. In certain systems, only UE 610 and eNB 620 may be present, and in other systems UE 610, eNB 620, and a plurality of other user equipment may be present. Other configurations are also possible. The core network element 630 may be, for example, an MME.

Each of these devices may include at least one processor, respectively indicated as 614, 624, and 634. At least one memory can be provided in each device, as indicated at 615, 625, and 635, respectively. The memory may include computer program instructions or computer code contained therein. The processors 614, 624, and 634 and memories 615, 625, and 635, or a subset thereof, can be configured to provide means corresponding to the various blocks of FIG. 5. Although not shown, the devices may also include positioning hardware, such as global positioning system (GPS) or micro electrical mechanical system (MEMS) hardware, which can be used to determine a location of the device. Other sensors are also permitted and can be included to determine location, elevation, orientation, and so forth, such as barometers, compasses, and the like.

As shown in FIG. 6, transceivers 616, 626, and 636 can be provided, and each device may also include at least one antenna, respectively illustrated as 617, 627, and 637. The device may have many antennas, such as an array of antennas configured for multiple input multiple output (MIMO) communications, or multiple antennas for multiple radio access technologies. Other configurations of these devices, for example, may be provided. For example, core network element 630 may be configured for wired communication, rather than wireless communication, and in such a case antenna 637 would illustrate any form of communication hardware, without requiring a conventional antenna.

Transceivers 616, 626, and 636 can each, independently, be a transmitter, a receiver, or both a transmitter and a receiver, or a unit or device that is configured both for transmission and reception.

Processors 614, 624, and 634 can be embodied by any computational or data processing device, such as a central processing unit (CPU), application specific integrated circuit (ASIC), or comparable device. The processors can be implemented as a single controller, or a plurality of controllers or processors.

Memories 615, 625, and 635 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 610, eNB 620, and core network element 630, to perform any of the processes described above (see, for example, FIGS. 1 through 5). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 6 illustrates a system including a UE, eNB, and core network element, embodiments of the invention may be applicable to other configurations, and configurations involving additional elements.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1.-44. (canceled)

45. A method, comprising:
entering a transaction state by a user equipment; and
suspending reception of paging messages during an idle period of the transaction state.

46. The method of claim 45, wherein the suspending reception of paging messages comprises paging not being supported by the user equipment during the idle period or paging being supported but suspended by the network during the idle period.

47. The method of claim 45, further comprising:
reconnecting to a radio access network when the idle period ends or when the user equipment has data to send on uplink.

48. The method of claim 47, wherein the reconnecting comprises sending a tracking area update message or a radio resource control message.

49. The method of claim 47, further comprising:
receiving downlink data during an active period after reconnection to the radio access network.

50. The method of claim 49, further comprising:
re-entering the idle period after receiving the downlink data or a message.

51. An apparatus, comprising:
at least one processor; and
at least one memory including computer program code,
wherein the at least one memory and the computer program code are configured to, with the at least one processor, cause the apparatus at least to
enter a transaction state; and
suspend reception of paging messages during an idle period of the transaction state.

52. The apparatus of claim 51, wherein the at least one memory and the computer program code are configured to, with the at least one processor, cause the apparatus at least to suspend reception of paging messages by paging not being supported by the user equipment during the idle period or paging being supported but suspended by the network during the idle period.

53. The apparatus of claim 51, wherein the at least one memory and the computer program code are configured to, with the at least one processor, cause the apparatus at least to reconnect to a radio access network when the idle period ends or when the user equipment has data to send on uplink.

54. The apparatus of claim 53, wherein the at least one memory and the computer program code are configured to, with the at least one processor, cause the apparatus at least to reconnect by sending a tracking area update message or a radio resource control message.

55. The apparatus of claim 53, wherein the at least one memory and the computer program code are configured to, with the at least one processor, cause the apparatus at least to receive downlink data during an active period after reconnection to the radio access network.

56. The apparatus of claim 55, wherein the at least one memory and the computer program code are configured to, with the at least one processor, cause the apparatus at least to re-enter the idle period after receiving the downlink data or a message.

57. The apparatus of claim 51, wherein the at least one memory and the computer program code are configured to, with the at least one processor, cause the apparatus at least to negotiate or re-negotiate a periodicity of the transaction state.

58. An apparatus, comprising:
means for entering a transaction state by a user equipment; and
means for suspending reception of paging messages during an idle period of the transaction state.

59. The apparatus of claim 58, wherein the suspending reception of paging messages comprises paging not being supported by the user equipment during the idle period or paging being supported but suspended by the network during the idle period.

60. The apparatus of claim 58, further comprising:
means for reconnecting to a radio access network when the idle period ends or when the user equipment has data to send on uplink.

61. The apparatus of claim 60, wherein the reconnecting comprises sending a tracking area update message or a radio resource control message.

62. The apparatus of claim 60, further comprising:
means for receiving downlink data during an active period after reconnection to the radio access network.

63. The apparatus of claim 62, further comprising:
means for re-entering the idle period after receiving downlink data or a message.

64. A non-transitory computer-readable medium encoded with instructions that, when executed in hardware, perform a process, the process comprising the method according to claim 45.
